(19) United States
(12) Patent Application Publication
(10) Pub. No.: US 2010/0123848 A1
(43) Pub. Date: May 20, 2010

(54) LED MODULE AND LIQUID CRYSTAL DISPLAY HAVING THE SAME

(75) Inventors: Boing-jo KANG, Suwon-si (KR); Kyoung-choul JANG, Suwon-si (KR); Won-yong LEE, Suwon-si (KR); Sang-ik KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/493,571

(22) Filed: Jun. 29, 2009

(30) Foreign Application Priority Data
Nov. 18, 2008 (KR) 10-2008-0114625

(51) Int. Cl. G02F 1/1333; F21V 7/04

(52) U.S. Cl. 349/58; 362/612

(57) ABSTRACT

A light emitting diode (LED) module includes a plurality of LEDs which emit light, and a metal substrate on which the LEDs are mounted and which includes a fixing part to be directly fixed to an outer frame, wherein the metal substrate is a heat sink that absorbs heat generated by the LEDs.

### CROSS-REFERENCE TO RELATED APPLICATIONS

This application claims priority from Korean Patent Application No. 10-2008-114625, filed on Nov. 18, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to a liquid crystal display, and more particularly, to a light emitting diode (LED) module used in a liquid crystal display.

2. Description of the Related Art

Liquid crystal displays are a kind of display apparatus that has been widely used for its light weight, compact size, and capability of realizing full-color and high resolution. The liquid crystal display displays images using a liquid crystal which is a light receiving element incapable of emitting light by itself. Therefore, a backlight unit is required to supply light to a liquid crystal panel.

Lamps are mainly used as a light source for the backlight unit. Recently, for the purpose of achieving compactness of the liquid crystal display, an attempt has been made to apply a light emitting diode (LED) to the backlight unit. Since a single liquid crystal display requires many LEDs, an LED module having a plurality of LEDs is preferred. With the application of the LEDs to the backlight unit, components necessary for the lamp such as an inverter are not required and noise by high voltage can be reduced.

The LED emits a large amount of heat if the liquid crystal display is used for a long time. The high temperature reduces a lifespan of the LED and causes the LED to be defective. Therefore, a heat dissipating device is required to dissipate heat generated in the LED. However, due to such an extra heat dissipating device, the number of manufacturing processes increases and a manufacturing cost increases.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an LED module, which simplifies a manufacturing process and effectively cools an LED, and a liquid crystal display having the same.

According to an aspect of the present invention, an LED module includes a plurality of LEDs which emit light, and a metal substrate on which the LEDs are mounted and which has a fixing part to be directly fixed to an outer frame, wherein the metal substrate itself absorbs heat generated by the LEDs.

The LEDs may be integrally formed with the metal substrate.

The metal substrate may include a first metal substrate on which the LEDs are mounted, and a second metal substrate on which the fixing part is formed and which absorbs heat generated by the LEDs.

The first and the second metal substrates may be adhered to each other by soldering.

The fixing part may be a through hole which is formed on a surface neighboring one surface of the metal substrate on which the LEDs are mounted.

The fixing part may be a through hole which is formed on a surface opposite one surface of the metal substrate on which the LEDs are mounted.

The metal substrate may have a thickness ranging from two times to ten times larger than a width of the LEDs.

According to another aspect of the present invention, a liquid crystal display includes a liquid crystal panel which displays an image, an LED module which supplies light to the liquid crystal panel, and a light guide plate which guides light emitted from the LED module toward the liquid crystal panel.

Additional and/or other aspects and advantages of the invention will be set forth in part in the description which follows and, in part, will be obvious from the description, or may be learned by practice of the invention.

### BRIEF DESCRIPTION OF THE DRAWING FIGURES

The above and/or other aspects of the present invention will be more apparent by describing certain exemplary embodiments of the present invention with reference to the accompanying drawings, in which:

FIG. 1 is an exploded perspective view of a liquid crystal display consistent with an exemplary embodiment of the present invention;

FIG. 2 is an enlarged view of the LED module of FIG. 1; and

FIG. 3 is a view of an LED module consistent with another exemplary embodiment of the present invention.

### DETAILED DESCRIPTION OF THE EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

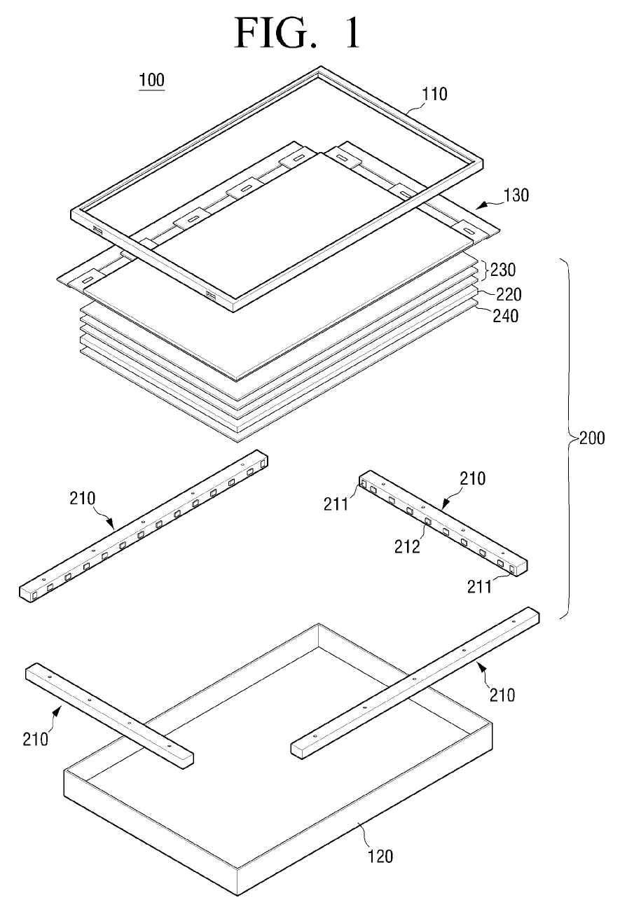

FIG. 1 is an exploded perspective view of a liquid crystal display according to an exemplary embodiment of the present invention.

As shown in FIG. 1, a liquid crystal display 100 comprises an upper casing 110, a lower casing 120, a liquid crystal panel 130, and a backlight unit 200.

The upper casing 110 and the lower casing 120 together form the exterior of the liquid crystal display 100 and fix interior components of the liquid crystal display 100.

The liquid crystal panel 130 displays an image using light supplied from the backlight unit 200. Since the operation and function of the liquid crystal panel 130 is readily understood by a person of ordinary skill in the related art, a detailed description thereof will be omitted.

The backlight unit 200 supplies light to the liquid crystal panel 130 and includes an LED module 210, a light guide plate 220, an optical sheet 230, and a reflective sheet 240.

The LED module 210 is used as a light source for the backlight unit 200 and is disposed around edges of the liquid crystal panel 130.

The light guide plate 220 guides light emitted from LEDs 211 toward the light crystal panel 130. The light guide plate 220 is a flat board having a predetermined thickness and may be formed of transparent acryl, polymethylmethacrylate, plastic or glass.

The optical sheet 230 is disposed on the light guide plate 220 and diffuses and collects light directed to the liquid crystal panel 130. The optical sheet 230 may comprises a diffusing plate (not shown) and a prism sheet (not shown).

The reflective sheet 240 is disposed under the light guide plate 220 and reflects light directed downward from the light guide plate 220 toward the liquid crystal panel 130.

The light guide plate 220, the optical sheet 230, and the reflective sheet 240 can be easily understood by an ordinary skilled person in the related art and thus detailed description thereof will be omitted.

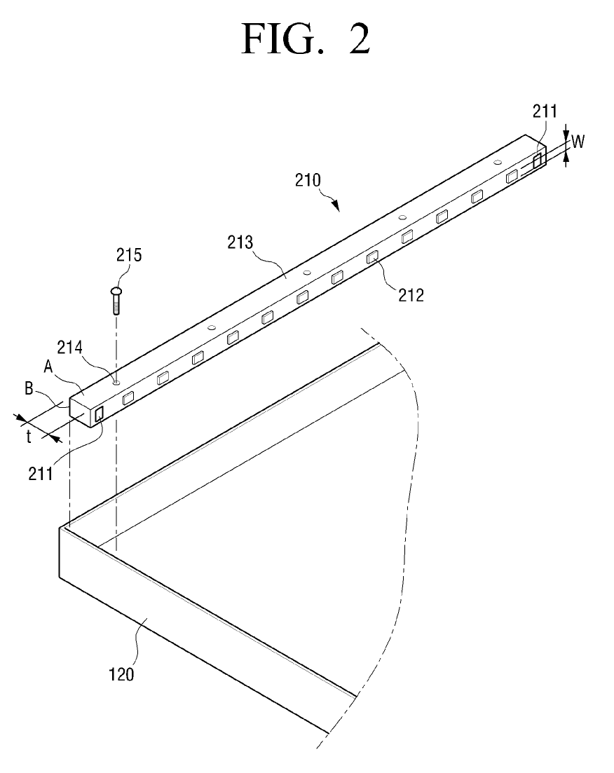

FIG. 2 is an enlarged view of the LED module 210 of FIG. 1. Referring to FIG. 2, the LED module 210 will be described in greater detail.

The LED module 210 comprises a plurality of connectors 211, a plurality of LEDs 212, and a metal substrate 213.

The connectors 211 are connected to a power supply (not shown) to supply power to the LEDs 212. The connectors are located at opposite ends of the metal substrate 213.

The LEDs 212 are mounted on a surface of the metal substrate 213 in line. The LEDs 212 are electrically connected to one another through a wire (not shown). If power is supplied to the LEDs 212, the LEDs 212 emit light toward the light guide plate 220.

If the liquid crystal display 100 is used for a long time, the temperature of the LEDs 212 greatly increases. In order to prevent damage to the LEDs 212, dissipation of the heat generated by the LEDs 212 is required. According to a related art method of dissipating heat, an extra heat dissipating device is attached to the metal substrate 213. However, there is a minute air gap between the heat dissipating device and the metal substrate 213, which increases heat resistance and deteriorates heat dissipating performance of the LEDs 212. Due to an additional process of attaching the heat dissipating device to the metal substrate 213, the number of manufacturing processes increases and the manufacturing cost increases.

According to an exemplary embodiment of the present invention, the metal substrate 213 itself serves as a heat sink to absorb heat generated by the LEDs 212. To this end, the metal substrate 213 has a predetermined thickness (t) which is sufficient to serve as a heat sink and is integrally formed with the LEDs 212. Since the heat generated by the LEDs 212 is directly transmitted to the metal substrate 213, no air gap is created and accordingly heat dissipating performance of the LEDs 212 is improved. Also, an additional process of attaching an extra heat dissipating device is not required.

As the thickness of the metal substrate 213 increases, the cost increases and the size of the liquid crystal display 100 increases. Accordingly, there is necessity to adjust the thickness of the metal substrate 213 properly. The thickness of the metal substrate 213 may be about two times to about ten times larger than the width (w) of the LEDs 212.

The metal substrate 211 comprises a fixing part 214 to fix the LED module 210 to an outer frame directly. According to an exemplary embodiment of the present invention, the lower casing 120 corresponds to the outer frame. Conventionally, an extra component is required to fix the LED module 210 to the lower casing 120. However, according to an exemplary embodiment of the present invention, since the fixing part 214 is integrally formed with the metal substrate 213, an extra component for fixing the LED module 210 is not required. Accordingly, the manufacturing process can be simplified.

As shown in FIG. 2, the fixing part 214 may be a through hole. According to an exemplary embodiment of the present invention, the through hole 214 is provided on a surface A neighboring the surface of the metal substrate 213 on which the LEDs 212 are mounted. However, this should not be considered as limiting since the through hole 214 may be provided on other surfaces of the metal substrate 213. For example, the through hole 214 may be provided on a surface B opposite the surface of the metal substrate 213 on which the LEDs 212 are mounted. A screw is inserted into the through hole 214 to fix the LED module 210 to the lower casing 120.

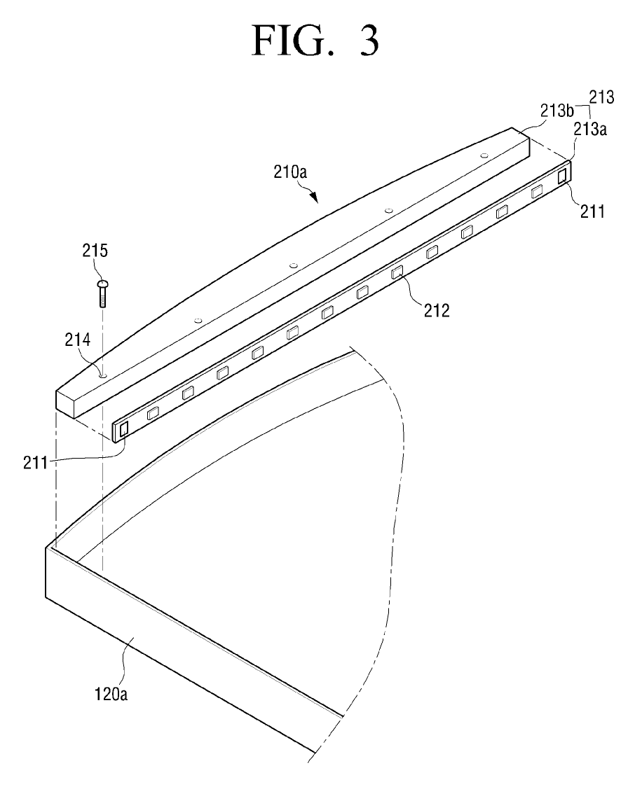

FIG. 3 is a view of an LED module according to another exemplary embodiment of the present invention.

The same reference numerals are used for the same elements as in the aforementioned embodiment.

According to another exemplary embodiment of the present invention, an LED module 210a comprises a plurality of connectors 211, a plurality of LEDs 212, and a metal substrate 213.

The metal substrate 213 comprises a first metal substrate 213a and a second metal substrate 213b.

The LEDs 212 are mounted on the first metal substrate 213a which is has a thin plate shape.

A fixing part 214 is provided on the second metal substrate 213b. Since the second metal substrate 213b serves as a heat sink to absorb heat generated by the LEDs 212, the second metal substrate 213b has a predetermined thickness which is sufficient to serve as a heat sink.

If a lower casing 120a has a complicated shape, such as a curved surface rather than a rectangular shape, the metal substrate 213 should have a shape corresponding to the lower casing 120a. In this case, it is difficult to integrally form the LEDs 212 with the metal substrate 213. In order to solve this problem, another exemplary embodiment of the present invention uses the first metal substrate 213a and the second metal substrate 213b. Since the first metal substrate 213a has a thin plate shape, the LEDs 212 can be easily mounted on the first metal substrate 213a. The second metal substrate 213b has a shape corresponding to the lower casing 120a.

The first and the second metal substrates 213a, 213b may be adhered to each other by soldering, adhesive or other techniques known in the art. Since the first and the second metal substrates 213a, 213b are adhered to each other, an air gap is not created between the first and the second metal substrates 213a, 213b, thereby improving the heat dissipating performance of the LEDs 212.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A light emitting diode (LED) module comprising:
a plurality of LEDs which emit light; and
a metal substrate on which the LEDs are mounted and which includes a fixing part to be directly fixed to an outer frame,
wherein the metal substrate is a heat sink that absorbs heat generated by the LEDs.

2. The LED module as claimed in claim 1, wherein the LEDs are integrally formed with the metal substrate.

3. The LED module as claimed in claim 1, wherein the metal substrate comprises:
a first metal substrate on which the LEDs are mounted; and
a second metal substrate which includes the fixing part and absorbs heat generated by the LEDs.

4. The LED module as claimed in claim 3, wherein the first and the second metal substrates are adhered to each other by soldering.

5. The LED module as claimed in claim 1, wherein the fixing part comprises a through hole which is provided on a surface neighboring a surface of the metal substrate on which the LEDs are mounted.

6. The LED module as claimed in claim 1, wherein the fixing part is a through hole which is formed on a surface opposite a surface of the metal substrate on which the LEDs are mounted.

7. The LED module as claimed in claim 1, wherein the metal substrate has a thickness ranging from two times to ten times larger than a width of the LEDs.

8. The LED module as claimed in claim 1, wherein the metal substrate has a shape which corresponds to the outer frame.

9. The LED module as claimed in claim 1, wherein the outer frame has a curved shape.

10. A liquid crystal display comprising:
a liquid crystal panel which displays an image;
a light emitting diode (LED) module which supplies light to the liquid crystal panel;
a light guide plate which guides light emitted from the LED module toward the liquid crystal panel; and
an outer frame,
wherein the LED module comprises:
a plurality of LEDs which emit light; and
a metal substrate on which the LEDs are mounted and which includes a fixing part to be directly fixed to the outer frame,
wherein the metal substrate is a heat sink that absorbs heat generated by the LEDs.

11. The liquid crystal display as claimed in claim 10, wherein the LEDs are integrally formed with the metal substrate.

12. The liquid crystal display as claimed in claim 10, wherein the metal substrate comprises:
a first metal substrate on which the LEDs are mounted; and
a second metal substrate which includes the fixing part and absorbs heat generated by the LEDs.

13. The liquid crystal display as claimed in claim 12, wherein the first and the second metal substrate are adhered to each other by soldering.

14. The liquid crystal display as claimed in claim 10, wherein the fixing part comprises a through hole which is provided on a surface neighboring a surface of the metal substrate on which the LEDs are mounted.

15. The liquid crystal display as claimed in claim 10, wherein the fixing part is a through hole which is formed on a surface opposite a surface of the metal substrate on which the LEDs are mounted.

16. The liquid crystal display as claimed in claim 10, wherein the metal substrate has a thickness ranging from two times to ten times larger than a width of the LEDs.

17. The LED module as claimed in claim 1, wherein the metal substrate has a shape which corresponds to the outer frame.

18. The LED module as claimed in claim 1, wherein the outer frame has a curved shape.
